(19) United States
(12) Patent Application Publication
(10) Pub. No.: US 2006/0142139 A1
(43) Pub. Date: Jun. 29, 2006

(54) Heavy metal oxide thin films active and passive planar waveguide and optical devices

(76) Inventor: Mohammed Saad, lle des Soeurs (CA)

Correspondence Address: Louis Tessier, P O Box 54029, Town of Mount-Royal, QC, H3P 3H4, CA

(21) Appl. No.: 10/515,824

(22) PCT Filed: May 27, 2003
(86) PCT No.: PCT/CA03/00767

§ 371 Date: Nov. 26, 2004

(30) Foreign Application Priority Data
May 27, 2002 (CA) 2386380

(51) Int. Cl. C03C 13/04

(52) U.S. Cl. 501/37

(57) ABSTRACT

The purpose of the invention is heavy metal oxide thin films and their applications. These thin films will serve to produce doped and undoped planar wave-guides and planar lightwave circuit (PLC) for passive and active optical devices (amplifier, laser, filter, multiplexer, attenuators and . . . ). These thin films present low loss, good chemical and thermal stability and wide optical transmission window, high solubility of all rare earth ions and transition metals ions . . . . They can be deposited on different substrates.

### BACKGROUND OF THE INVENTION

The present invention related to the field of optical thin film used as passive or active light wave-guides (laser and amplifiers medium, attenuator . . . ). These thin films present a wide transmission window, low loss, high solubility of rare-earth, actinide and transition metal elements and a good mechanical and chemical and thermal stability. More particularly, the composition of these films can be easily adjusted in a wide rang to optimize their optical properties (refractive index and optical losses . . . ), mechanical (thermal expansion coefficient . . . ) and chemical properties. Unlike other optical materials, especially silica and chalcogenide based thin film, these films can be doped with high concentration of all rare-earth, Nd, Pr, Tm, Er . . . , and transition metal ions, Co, V, cu, Fe, Ni, Mn, which make them suitable for high performance planar wave-guide active devices. Furthermore, as they present low optical loss they are suitable also for passive optical devices as multiplexer and de-multiplexer devices.

Furthermore, planar wave-guide circuit can be written directly in photosensitive doped thin film by a UV laser. They can also be obtained by using the photolithography method.

The present invention is motivated by the increasing demand of small and cost effective passive and active optical devices, such as planar wave-guide circuits, integrated devices, such as optical amplifiers, lasers, attenuators, filter, multiplexer . . . for telecommunication field.

In my previous invention, the U.S. Pat. No. 5,342,809 Process for the synthesis of fluoride glass by sol-gel method and optical fiber produced from the fluoride glass obtained according to this process, oxide gel compositions were limited to those of fluoride glasses. And no heavy oxide thin film and their application as planar waveguide were claimed. Oxide gel have been only obtained as powder and dried at temperature ranging from 20 to 120 C, and then fluorinated using gaseous HF to obtain fluoride glass powder. In addition, compositions which were claimed didn't include photosensitive elements such as GeO2, or SnO2 or Ce, and transition metal ions . . . . Furthermore, this process has to be optimized to obtain the heavy oxide thin film.

The U.S. Pat. No. 6,143,272, Sol-Gel processed metal-zircona materials concern only crystalline binary materials, the patent doesn't cover amorphous materials.

The U.S. Pat. No. 5,801,105, Multilayer thin film, substrate for electronic device, electronic device, and preparation of multilayer oxide thin film, concern crystalline material also.

The U.S. Pat. No. 6,122,429, Rare-earth doped barium titanate thin film optical working medium for optical devices, is limited to binary compositions in BaO—TiO2 system.

Examples of composition in molar %

| | | | | | | Rare-earth ions | | |
|---|---|---|---|---|---|---|---|---|
| | | | Sr, Ca, | Al, In, | La, | at least one Nd, | Ge, | Na, Li, |
| Zr | Hf | Ba | Mg | Ga | Y | Pr, Er, Tm . . . | Sn | K |
| 30 | 20 | 20 | 10 | 5 | 10 | 5 | | |
| 45 | 25 | | 10 | 5 | 10 | 5 | | |
| 53 | | 40 | | | 4 | 3 | | |
| 45 | 10 | 15 | 10 | 10 | 5 | | 5 | |
| 70 | | 10 | | 5 | 5 | | | 10 |
| 53 | 25 | | 15 | | | 2 | 5 | |
| 47 | | 46 | | 5 | | 2 | | |
| 63 | | 20 | | | 5 | 2 | | 10 |

### DETAILED DESCRIPTION OF INVENTION

Accordingly the present invention provides a process for making a wide variety of Zirconium oxide based thin films with very good mechanical and optical properties, to be used as waveguide, protection and/or antireflection thin films.

These heavy metal oxide thin films are obtained by sol-Gel process. The oxide gel is obtained by mixing Organometallique starting materials in alcohol solvent. Some elements which concentration is lower than 20 molar percent can be added as salts (Chloride, acetate, oxalate, carbonate and nitrate . . . ). The gel is then obtained by acidic hydrolysis and condensation at temperature between 35 and 75° C. for 30 to 90 minutes according to gel composition. It is not recommended to use nitrate salts when strontium and/or Barium ions are present in the solution.

The coating is applied on different substrates by conventional spin coating or dip coating or vaporization methods. The thin films are carefully dried first at ambient temperature and then in an inert or reactive atmosphere (under O2, N2, Cl2 . . . ) at temperature ranging from 60 to 500° C. for 30 min to 2 hours according to thin films composition.

As far as waveguides are concerned, photosensitive ions are added to the starting solution used to prepare the gel, and waveguide are directly written using a laser beam in the dried thin film.

The present invention further provides a process for making rare-earth doped optical fiber which comprise (1) mixing the zirconium based gel, which contain 0.5 to 20 molar percent of rare-earth element, with a silica gel in the proportion 1 to 30 molar percent of gel of zirconium based gel doped with rare earth elements and 99 to 70 molar percent of silica gel. (2) Providing deposition some layers of the mixed gel directly on the inner part of silica tube or on porous soot already deposited on the inner part of silica tube, at room temperature. (3) Drying the deposited layer under oxygen at temperature ranging from 500 to 800° C. during 1 to 2 hours. (4) Dehydrating the core layer of the tube at a temperature ranging from 600 to 800 C for 1 hour. (5) Sintering the core layer at temperature ranging from 1500 to 1800° C. (6) Collapsing the tube according to classical way used in silica fiber technology to obtain a perform. The doped optical fiber is obtained by drawing it from this preform.

### EXAMPLE 1

A binary gel is obtained by mixing zirconium iso-propoxide and barium methoxide or ethoxide in iso-propanol. The gel contained a relative cationic composition of 50% of Zr and 50% of Ba. The mixture was heated at 60 C for 30 minutes and then hydrolyzed with an acetic acid solution. Stirring was maintained for 30 additional minutes. After cooling the solution is poured into a container to obtain a stable dried gel.

### EXAMPLE 2

A ternary stable gel has been obtained by using zirconium iso-propoxide, barium ethoxide and aluminum methoxide in iso-propanol alcohol. The gel contained a relative cationic composition of 60% Zr, 30% Ba and 10% Al. The mixture was heated up to 60 C for 45 minutes and then hydrolyzed with an acetic acid solution. Stirring was maintained for 40 minutes. After cooling, the solution has been poured into a container. A wet stable gel has been obtained after 2 days.

### EXAMPLE 3

A wet oxide gel has been obtained by mixing zirconium methoxide, Barium methoxide, and Sodium methoxide in methanol. The gel contained a relative cationic composition of 50% Zr, 20%, and 20% Na, 5% La and 5% Al. The mixture has been heated up to 50 C during 30 minutes, and then hydrolyzed with acetic acid solution. Stirring was maintained for 30 minutes. After cooling and drying at room temperature, a stable and transparent gel was obtained after 30 hours.

Stable and transparent thin films can be obtained form wet oxide gels after hydrolysis and condensation steps, with appropriate viscosity by conventional spin coating or dip coating techniques. Spin coating and dip coating are conventional techniques and will not be described in details.

### Sol-Gel Process for the Preparation of Thin Films

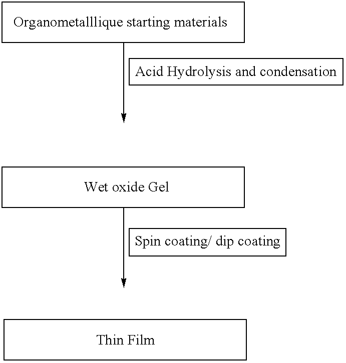

What we claim:

1: Heavy metal oxide thin films composition (X in % molar):
X₁ % M₁Oₙ₁-X₂ % M₂Oₙ₂-X₃ % M₃Oₙ₃-X₄ % M₄Oₙ₄-X₅ % M₅Oₙ₅-X₆ % M₆Oₙ₆
40≦X₁≦100%
0≦X₂≦60%
0≦X₃≦60%
0≦X₄≦60%
0≦X₅≦60%
0≦X₆≦50%
0≦X₂+X₃+X₄+X₅+X₆≦60%

2. The constituent of the heavy metal oxide thin films are selected from transition metal, lanthanide ions, actinide elements, and elements of group Ia, IIa, IIIa, IVa, Va, IIb, IIIb, IVb, Vb of the periodic table.

3: The cation M1 according to claim 1 is at least one of cations selected among Zr, Hf, Ti, Zn and Cd

4: the cation M2 according to claim 1 is at least one of cations selected from alkaline earth metal, Barium and or strontium, and or calcium and or magnesium

5: The cation M3 according to claim 1 is at least one of cations selected in alkali element cations, Lithium, Sodium, Potassium . . . .

6: the cation M4 is at least one cations selected from the group 3A in periodic table consisting of Al, Ga, In . . .

7: The cation M5 according to claim 1 is at least one cation from the group 4A consisting of Si, Ge, Sn, Pb

8: The cation M6 according to claim 1 is at least one cation from 3B group of periodic table consisting of Sc, Y, La

9: The oxide thin films according to claim 1 which contain at least one element from photosensitive ions and not limited to Ge, Ce, Sn

10: The heavy oxide thin films according to claim 1 which contain at least 0.05% of at least one of transition metal oxides selected from the group consisting of Co, V, Cr, Ag, Cu, Fe, Ni, Mn, . . .

11: The Heavy metal oxide thin films according to claim 1 which contain at least 0.01 w % of at least one of rare-earth oxide selected from the group consisting of La, Ce, Er, Pr, Nd, Tm, Ho, Dy, Yb . . .

12: Thin films according to claim 11 is dried at a temperature higher than 20 [symbol] C in air or under reactive or inert gas atmosphere, containing at least one element, and not limited to, from CCl.sub.4, Cl.sub.2, O.sub.2, N.sub.2, He, Ar, Ne, H.sub.2, HCl, HF, F.sub.2, HBr, H.sub.2.S, SF.sub.6 . . . .

13: Thin films according to claim 10 is dried at a temperature higher than 20 [symbol] C in air or under reactive or inert gas atmosphere, containing at least one element, and not limited to, from CCl.sub.4, Cl.sub.2, O.sub.2, N.sub.2, He, Ar, Ne, H.sub.2, HCl, HF, F.sub.2, HBr, H.sub.2.S, SF.sub.6 . . .

14: The thin films according to claim 11 which contain at least 0.1% of photosensitive element such as GeO.sub.2, CeO.sub.2 and SnO.sub.2

15: the thin films according to claim 10 which contain at least 0.1% of photosensitive element such as GeO.sub.2, CeO.sub.2 and SnO.sub.2

16: Thin films according to claim 1 is deposited as Multilayer oxide thin films

17: Multilayer oxide thin films according to claim 14 is doped with at least 0.01% of at least one of rare-earth oxide selected from the group consisting of La, Ce, Er, Pr, Nd, Tm, Ho, Dy, Yb . . .

18: Thin films according to claim 1 is dried at a temperature higher than 20 [symbol] C in air or under reactive or inert gas atmosphere, containing at least one element, and not limited to, from CCl.sub.4, Cl.sub.2, O.sub.2, N.sub.2, He, Ar, Ne, H.sub.2, HCl, HF, F.sub.2, HBr, H.sub.2S, SF.sub.6 . . .

19: The heavy metal oxide thin films according to claim 1 which contain at least 0.01% of at least one of actinide ions.

20: Thin films according to claim 1 is used as a cladding for fluoride glass fibers

21: Thin film according to claim 1 is used as protecting coating for fluoride glass fibers

22: Thin film according to claim 1 is a cladding for an optical fiber

23: Thin film according to claim 1 is a core of an optical fiber

24: Thin film according to claim 11 is a core of an optical fiber

25: Thin film according to claim 10 is a core of an optical fiber

26: Thin film according to claim 16 is used as multi-cladding for an optical fiber

27: Thin film according to claim 1 is used in optical devices

28: Thin film according to claim 12 is used in optical devices

29: Thin film according to claim 13 is used in optical devices

30: Thin film according to claim 16 is used in optical devices

31: Thin film according to claim 17 is used in optical devices

32: Thin film according to claim 9 is used in optical devices

33: Thin film according to claim 14 is used in optical devices

34: Thin film according to claim 15 is used in optical devices

35: thin film according to claim 1 are used as protection and/or antireflection coating on infrared amorphous materials, such as and not limited to halide glasses, oxy-halide glasses, chalcogenide glasses, Germanium oxide based glasses . . .

36: thin film according to claim 1 are used as protection and/or antireflection coating on crystalline infrared materials, such as and not limited to, sapphire (Al2O3), ZnS, ZnSe, yttrium oxide (Y2O3).

37: Thin film according to claim 19 are used as optical filters.

38: Thin films according to claim 11 are used as optical filters.
